(19) United States
(12) Patent Application Publication
(10) Pub. No.: US 2005/0066697 A1
(43) Pub. Date: Mar. 31, 2005

(54) Slow-release polyurethane(urea) encapsulated fertilizer

(76) Inventors: Robert Lee Cline, Paden City, WV (US); Peter H. Markusch, Sanibel, FL (US); Ralf Guether, Bergisch Gladbach (DE)

Correspondence Address: BAYER MATERIAL SCIENCE LLC, 100 BAYER ROAD, PITTSBURGH, PA, 15205, US

(21) Appl. No.: 10/675,536

(22) Filed: Sep. 30, 2003

(51) Int. Cl. C05C 9/00

(52) U.S. Cl. 71/28

(57) ABSTRACT

This invention relates to polyurethane(urea) encapsulated fertilizer particles which exhibit slow-release properties and to a process for their production. In one embodiment, the process comprises a) applying a polyisocyanate component to fertilizer particles to form isocyanate coated fertilizer particles, b) mixing an inert inorganic filler with said isocyanate coated fertilizer, c) adding an isocyanate-reactive component to the mixture of step b) and d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

### BACKGROUND OF THE INVENTION

This invention relates to polyurethane(urea) encapsulated fertilizers exhibiting improved slow-release properties and to a process for the production of these encapsulated fertilizers.

Commercial particulate fertilizers are produced and marketed in several different particle types, i.e., granular, pelletized, dusts, pilled, and prilled fertilizers. Also, they may be formed of inorganic substances, organic substances, or combinations thereof.

In order to be effective in promoting plant growth, fertilizers must contain some amounts of water soluble plant nutrients. These are typically in the form of water soluble compounds of nitrogen, phosphorus and potassium, alone or in combination, and often in conjunction with other elements, such as, for example, calcium, boron, magnesium, zinc, chlorine, etc. Such particulate fertilizers can be made of a single component, e.g., urea, ammonium nitrate, potassium chloride, etc., or of multiple components often mixed with inert water soluble or water insoluble materials as in common fertilizers designated as 6-6-6, 4-6-4, 10-10-10, 20-20-5, 14-16-0, 5-20-20, and the like. In addition, specialized fertilizers may contain optional additives such as herbicides, insecticides, trace elements, iron salts, sulfur, and the like.

Historically, particulate fertilizers possessed a number of known defects, the most notable being the too rapid release of soluble plant food, causing phytotoxicity and the rapid depletion of the plant nutrients by leaching. Other problems included tendencies to cake and form dust.

Recently, polyurethane- and polyurethaneurea-encapsulated fertilizers have gained commercial acceptance.

U.S. Pat. No. 5,851,261 relates to a process for the production of polyurea encapsulated fertilizer particles. This process comprises applying an isocyanate-reactive component containing at least two amine groups to the fertilizer particles, and applying a polyisocyanate to the amine coated particles to form polyurea coated particles. The order of applying the components may also be reversed, such that the polyisocyanate is applied first, followed by the amine group containing component.

Published Canadian application 2,275,925 describes a process for the production of encapsulated, slow-release biodegadable fertilizer compositions. The process steps are similar to those required by the process of U.S. Pat. No. 5,851,261. The isocyanate-reactive component suggested by this application can be a polyester polyol or polyether polyol having a functionality of 1.5 to 4 and a molecular weight of 500 to 5,000, and the polyisocyanate component is an organic aliphatic polyisocyanate.

Sulfur containing isocyanate compositions and a process for the production of encapsulated fertilizer compositions are described in U.S. Pat. No. 6,152,981. The fertilizer compositions are prepared by applying a mixture of sulfur and an isocyanate to the fertilizer and then applying an isocyanate-reactive material. The reference broadly suggests that inorganic fillers can also be used (see column 10, lines 21-23), but gives no indication as to how the fillers are to be included or as to the quantities of fillers to be used.

U.S. Pat. No. 6,358,369 describes a process comprising 1) applying an isocyanate-reactive oleo polyol to fertilizer particles to form coated fertilizer particles, and 2) applying a polyisocyanate component to the coated fertilizer particles to form polyurethane encapsulated fertilizer particles. These two steps are optionally repeated (successively) as many times as necessary to form the desired thickness of the polyurethane coating which encapsulates the fertilizer particles.

U.S. Pat. Nos. 6,001,147 and 6,165,550 both describe a process wherein an alkanolamine is first applied to a fertilizer, followed by application of a polyisocyanate. The steps can also be reversed.

Commonly-owned, pending U.S. patent application Ser. No. 09/976,610, filed on Oct. 12, 2001, describes a process of applying a polyisocyanate to a fertilizer and then applying a sulfur-containing isocyanate-reactive component. The steps can also be reversed.

U.S. Pat. No. 6,338,746 describes a process of first coating a fertilizer with a polymer, then coating the polymer with sulfur and thereafter applying a polymer coating. The polymers are described in U.S. Pat. Nos. 4,711,659, 4,804,403 and 5,374,292. These polymers require that the substrate contains a minimum quantity of reactive —NH₂ groups. Thus, these are not applicable to all fertilizer compositions for which slow release properties may be desirable. The '746 patent does describe that attempts to reduce polymer cost by the use of low-cost fillers, such as powdered limestone or clay have had slight success (see column 3, lines 26-48). Although the second table appearing in column 3 indicates that the filler is “in coating”, the reference gives no guidance as to how the filler should be incorporated. In addition, the reference indicates that the amount of filler that can be used is limited, “usually up to about 25% of the total coating applied.”

### DESCRIPTION OF THE INVENTION

This invention relates to a process for the production of polyurethane(urea) encapsulated slow release fertilizer particles, and to the polyurethane(urea) encapsulated slow release fertilizer particles produced by this process. The process of the invention can be conducted in several different ways.

In a first embodiment, the process comprises: a) applying a polyisocyanate component to fertilizer particles to form coated fertilizer particles, b) mixing an inert inorganic filler with said coated fertilizer particles, c) adding an isocyanate-reactive component to the mixture of step b) and d) allowing the reactive components to react to form filler containing polyurethane(urea) encapsulated fertilizer particles.

In a second embodiment, the process comprises a) applying a polyisocyanate component to fertilizer particles to form coated fertilizer particles, b) adding an isocyanate-reactive component to said coated fertilizer particles, c) mixing an inert inorganic filler with the mixture of step b) before the isocyanate and isocyanate-reactive component react and d) allowing the reactive components to react to form filler containing polyurethane(urea) encapsulated fertilizer particles.

In a third embodiment, the process comprises a) mixing fertilizer particles with an inert inorganic filler, b) applying a polyisocyanate component to the mixture to form a mixture of coated fertilizer particles and coated inert filler, c) adding an isocyanate-reactive component to the resultant mixture and d) allowing the reactive components to react to form filler containing polyurethane(urea) encapsulated fertilizer particles.

In a fourth embodiment, the process comprises: a) applying an isocyanate reactive component to fertilizer particles to form coated fertilizer particles, b) mixing an inert inorganic filler with said coated fertilizer particles, c) adding a polyisocyanate component to the mixture of step b) and d) allowing the reactive components to react to form filler containing polyurethane(urea) encapsulated fertilizer particles.

In a fifth embodiment, the process comprises a) applying an isocyanate reactive component to fertilizer particles to form coated fertilizer particles, b) adding a polyisocyanate to said coated fertilizer, c) mixing an inert inorganic filler with the mixture of step b) before the isocyanate and isocyanate-reactive component react and d) allowing the reactive components to react to form filler containing polyurethane(urea) encapsulated fertilizer particles.

In a sixth embodiment, the process comprises a) mixing fertilizer particles with an inert inorganic filler, b) applying an isocyanate reactive component to the mixture to form a mixture of coated fertilizer particles and coated inert filler, c) adding a polyisocyanate component to the resultant mixture and d) allowing the reactive components to react to form filler containing polyurethane(urea) encapsulated fertilizer particles.

Regardless of the embodiment chosen, the resultant filler containing polyurethane(urea) encapsulated fertilizer particles contain from about 1 to about 15 percent by weight of filled polyurethane(urea), with the percent by weight being based on the total weight of the encapsulated fertilizer, with the proviso that the weight ratio of polyurethane(urea) to filler is from about 80:20 to about 30:70. If these high amounts of filler are added first to either the isocyanate component or the isocyanate-reactive component, the viscosity becomes too high to satisfactorily mix the components on the surface of the fertilizer particles.

The encapsulated fertilizer compositions of the present invention preferably contain from about 1 to about 15%, and most preferably from about 4 to about 12% by weight of filled polyurethane(urea), based on the total weight of the encapsulated fertilizer composition. The preferred polyurethane(urea) to filler weight ratios are from about 80:30 to about 30:70 and most preferably from about 60:40 to about 40:60.

The steps of applying the components may be repeated (successively) as many times as necessary to form the desired thickness of the polyurethane(urea) coating which encapsulates the fertilizer particles.

The present invention also relates to encapsulated fertilizer compositions produced by these processes.

Suitable polyisocyanates which may be used in accordance with the present invention include monomeric diisocyanates, NCO prepolymers, and preferably liquid polyisocyanates and polyisocyanate adducts. Suitable monomeric diisocyanates may be represented by the formula R(NCO)₂ in which R represents an organic group obtained by removing the isocyanate groups from an organic diisocyanate having a molecular weight of about 56 to 1,000, preferably about 84 to 400. Diisocyanates preferred for the process according to the invention are those represented by the above formula in which R represents a divalent aliphatic, hydrocarbon group having 4 to 12 carbon atoms, a divalent cycloaliphatic hydrocarbon group having 6 to 13 carbon atoms, a divalent araliphatic hydrocarbon group having 7 to 20 carbon atoms or a divalent aromatic hydrocarbon group having 6 to 18 carbon atoms. Preferred monomeric diisocyanates are those wherein R represents an aromatic hydrocarbon group.

Examples of the suitable organic diisocyanates include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis(4-isocyanatocyclohexyl) methane, 2,4′-dicyclohexyl methane diisocyanate, 1,3- and 1,4-bis(isocyanatomethyl) cyclohexane, bis(4-isocyanato-3-methylcyclohexyl) methane, α,α,α′,α′-tetramethyl-1,3-and/or -1,4-xylylene diisocyanate, 1-isocyanato-1-methyl-4(3)-isocyanatomethyl cyclohexane, 2,4- and/or 2,6-hexahydrotoluene diisocyanate, 1,3- and/or 1,4-phenylene diisocyanate, 2,4- and/or 2,6-toluene diisocyanate, 2,4- and/or 4,4′diphenylmethane diisocyanate, 1,5-diisocyanato naphthalene and mixtures thereof. Aromatic polyisocyanates containing 3 or more isocyanate groups such as 4,4′,4″-triphenylmethane triisocyanate and polymethylene poly(phenyl-isocyanates) obtained by phosgenating aniline/formaldehyde condensates may also be used.

In accordance with the present invention, at least a portion of the polyisocyanate component may be present in the form of an NCO prepolymer or a polyisocyanate adduct, preferably a polyisocyanate adduct. Suitable polyisocyanate adducts are those containing isocyanurate, uretdione, biuret, urethane, allophanate, carbodiimide and/or oxadiazinetrione groups. The polyisocyanate adducts have an average functionality of 2.0 to 4 and an NCO content of 5 to 30% by weight. Suitable adducts/prepolymers include the following type of components:

1) Isocyanurate group-containing polyisocyanates which may be prepared as set forth in DE-PS 2,616,416, EP-OS 3,765, EP-OS 10,589, EP-OS 47,452, U.S. Pat. No. 4,288,586 and U.S. Pat. No. 4,324,879. The isocyanato-isocyanu rates generally have an average NCO functionality of 3 to 4.0, preferably of from 3.2 to 3.6, and an NCO content of 5 to 30%, preferably 10 to 25% and most preferably 15 to 25% by weight.

2) Uretdione diisocyanates which may be prepared by oligomerizing a portion of the isocyanate groups of a diisocyanate in the presence of a, i.e., trialkyl phosphine catalyst and which may be used in admixture with other aromatic, aliphatic and/or cycloaliphatic polyisocyanates, particularly the isocyanurate group-containing polyisocyanates set forth under (1) above.

3) Biuret group-containing polyisocyanates which may be prepared according to the processes disclosed in U.S. Pat. Nos. 3,124,605, 3,358,010; 3,644,490; 3,862,973; 3,906,126; 3,903,127; 4,051,165; 4,147,714; or 4,220,749 by using co-reactants such as water, tertiary alcohols, primary and secondary monoamines, and primary and/or secondary diamines. These polyisocyanates preferably have an NCO content of 18 to 22% by weight and an average NCO functionality of 3 to 3.5.

4) Urethane group-containing polyisocyanates which may be prepared in accordance with the process disclosed in U.S. Pat. No. 3,183,112 by reacting excess quantities of polyisocyanates, preferably diisocyanates, with low molecular weight glycols and polyols having molecular weights of less than 400, such as tripropylene glycol, trimethylol propane, glycerine, 1,2-dihydroxy propane and mixtures thereof. The urethane group-containing polyisocyanates have a most preferred NCO content of 12 to 20% by weight and an (average) NCO functionality of 2.5 to 3.

5) Allophanate group-containing polyisocyanates which may be prepared according to the processes disclosed in U.S. Pat. Nos. 3,769,318, 4,160,080 and 4,177,342. The allophanate group-containing polyiso-cyanates have a most preferred NCO content of 12 to 28% by weight and an (average) NCO functionality of 2 to 4.

6) Isocyanurate and allophanate group-containing polyisocyanates which may be prepared in accordance with the processes set forth in U.S. Pat. Nos. 5,124,427, 5,208,334 and 5,235,018; the disclosures of which are herein incorporated by reference.

7) Carbodiimide group-containing polyisocyanates which may be prepared by oligomerizing di- or polyisocyanates in the presence of known carbodiimidization catalysts as described in DE-PS 1,092,007, U.S. Pat. No. 3,152,162 and DE-OS 2,504,400, 2,537,685 and 2,552,350.

Preferred polyisocyanate adducts include the polyisocyanates containing urethane groups, isocyanurate groups, biuret groups or mixtures of isocyanurate and allophanate groups.

The NCO prepolymers, which may also be used as the polyisocyanate component in accordance with the present invention, can be prepared from the previously described polyisocyanates or polyisocyanate adducts, preferably monomeric diisocyanates, and organic compounds containing at least two isocyanate-reactive groups, preferably at least two hydroxy groups. These organic compounds include high molecular weight compounds having molecular weights of 500 to about 5,000, preferably 800 to about 3,000, and optionally low molecular weight compounds with molecular weights below 400. The molecular weights are number average molecular weights (Mn) and are determined by end group analysis (OH number). Products obtained by reacting polyisocyanates exclusively with low molecular weight compounds are polyisocyanate adducts containing urethane groups and are not considered to be NCO prepolymers.

It is preferred that the polyisocyanates of the present invention are aromatic polyisocyanates. Some examples of suitable aromatic poly-isocyanates are 1,3- and/or 1,4-phenylene diisocyanate, 2,4- and/or 2,6-toluene diisocyanate, 2,4- and/or 4,4′-diphenylmethane diisocyanate, 1,5-diisocyanato naphthalene and mixtures thereof.

It is more preferred that the polyisocyanates are polymethylene poly(phenylisocyanate) compositions having a functionality of from about 2.1 to about 3.5, preferably 2.2 to 3.2 and most preferably of 2.3 to 2.8, and an NCO group content of about 26% to about 33.4%, preferably about 30.5% to about 33%, and a monomeric diisocyanate content of from about 20% to about 90% by weight, preferably from about 40% to about 80%, wherein the content of monomeric diisocyanate comprises up to about 5% by weight of the 2,2′-isomer, from about 1 to about 25% by weight of the 2,4′-isomer, and from about 25 to about 70% by weight of the 4,4′-isomer, based on the entire weight of the isocyanate composition. The polymeric MDI content of these isocyanates varies from about 10 to about 80% by weight, preferably from about 20% to about 60% by weight.

“Polymeric MDI” as used herein, refers to polymethylene poly(phenyl-isocyanate) which in addition to monomeric diisocyanate (i.e., two-ring compounds) contains three-ring and higher ring containing products.

Most preferred polyisocyanates include, for example, poly-methylene poly(phenylisocyanate) compositions having an average functionality of from about 2.2 to about 3.2, preferably about 2.3 to about 2.8, an NCO group content of about 30 to 33% by weight, and a monomer content of from about 40 to 80% by weight, wherein the content of monomer comprises no more than about 2% by weight of the 2,2′-isomer, from about 2 to about 25% by weight of the 2,4′-isomer and from about 35 to about 60% by weight of the 4,4′-isomer, based on the entire weight of the composition. This isocyanate composition comprises from about 20 to about 60% by weight of polymeric MDI

A most preferred polyisocyanate comprises a polymethylene poly-(phenylisocyanate) having an NCO content of about 32.4%, a functionality of about 2.5, a viscosity of about 57 mPa·s at 25° C., and having a monomer content of about 61% by weight. Of the 61% monomer, about 18.0% by weight is the 2,4-isomer of MDI, about 2% by weight is the 2,2′-isomer of MDI and about 41% is the 4,4′-isomer of MDI.

Another most preferred polyisocyanate component comprises a polymethylene poly(phenylisocyanate) having an NCO content of about 32.3%, a functionality of about 2.8, a viscosity of about 160 mPa·s at 25° C., and having a monomer content of about 45% by weight. Of the 45% by weight monomer, about 44% is the 4,4′-isomer of MDI and about 1% by weight is the 2,4′-isomer of MDI.

Diphenylmethane diisocyanate which is rich in the 2,4′-isomer is another most preferred isocyanate for the present invention. Specifically, diphenylmethane diisocyanate having an isomer distribution comprising about 44% by weight of the 4,4′-isomer, about 54% by weight of the 2,4′-isomer and about 2% by weight of the 2,2′-isomer. This diisocyanate has an NCO content of about 33.6%, a functionality of about 2.0 and a viscosity of less than about 25 mPa·s at 25° C.

Also suitable are mixtures of polyisocyanate compositions as described above with adducts of MDI including, for example, allophanates of MDI as described in, for example, U.S. Pat. Nos. 5,319,053, 5,319,054 and 5,440,003, the disclosures of which are herein incorporated by reference; urethanes of MDI as described in, for example, U.S. Pat. Nos. 5,462,766 and 5,558,917, the disclosures of which are herein incorporated by reference; and carbodiimides of MDI as described in, for example, U.S. Pat. Nos. 2,853,473, 2,941,966, 3,152,162, 4,088,665, 4,294,719 and 4,244,855, the disclosures of which are herein incorporated by reference.

Isocyanate prepolymers including, for example, those based on diphenylmethane diisocyanate which may be based on either polyethers or polyesters are suitable for the present invention. Although these are typically less preferred isocyanates, these are suitable for fertilizer encapsulation processes, as long as they are liquid and can be applied according to the invention. These compounds include, for example, an isocyanate-terminated prepolymer having an NCO content of about 10%, a functionality of about 2 and a viscosity of about 2,500 mPa·s at 25° C. Such prepolymers can be prepared by, for example, reacting 2,4′-isomer rich MIDI with a difunctional polyether (prepared from propylene glycol and propylene oxide).

Suitable isocyanate-reactive compositions to be used in accordance with the presently claimed invention include, for example, those isocyanate-reactive compounds containing from 2 to 8 hydroxyl groups capable of reacting with the NCO groups of the polyisocyanate component, and having a molecular weight of from about 106 to about 1600, and an equivalent weight of about 31 to less than about 200. Suitable compounds to be used as the isocyanate-reactive composition in the present invention include, for example, diols, triols, tetrols and other higher functionality polyols, as well as polyether polyols, including for example, alkoxylation products of di-, tri- and higher functionality starter molecules such as, for example, ethylene glycol, propylene glycol, glycerol, trimethylolpropane, diethylene glycol, dipropylene glycol, tripropylene glycol, pentaerythritol, sucrose, sorbitol, and polyether polyols having an equivalent weight of less than 200 and a functionality of 2 to 8. Suitable polyether polyols can be prepared by reaction of the above listed hydroxyfunctional compounds with alkylene oxides such as propylene oxide and/or ethylene oxide.

It is preferred that the isocyanate-reactive compositions contain from 2 to 4 hydroxyl groups, and have a molecular weight of from 106 to 400 and an equivalent weight of from about 31 to less than about 100. It is more preferred that the isocyanate-reactive compositions contain from 2 to 3 hydroxyl groups, and have a molecular weight of 100 to 300 and an equivalent weight of from 50 to 100. Diethylene glycol and tripropylene glycol are particularly preferred isocyanate-reactive compositions for this embodiment.

It is also possible to utilize di- and/or polyamines as all or a portion of the isocyanate-reactive component, although the use of such amines is not preferred.

Other useful isocyanate reactive materials are known in the art and can be used in the present invention. Such materials water and the various isocyanate-reactive materials described in U.S. Pat. Nos. 6,001,147; 6,165,550; 6,358,296; and 6,364,925 and published Canadian application 2,275,925; all the disclosures of which are herein incorporated by reference.

Suitable inert inorganic fillers include substantially any inorganic material which is insoluble or substantially insoluble in water and which contain at least 50% by weight of particles having a particle size of less than 100 microns and preferably less than 50 microns. Such fillers are known and are described in U.S. Pat. No. 4,105,594, the disclosure of which is herein incorporarted by reference. Specific useful fillers include alumina, barium sulfate, carbon black, talc, calcium carbonate, kaolin clay, silicas, fly ash, hollow glass spheres and solid glass spheres.

It is also possible to include other additives in either the isocyanatereactive component or the polyisocyanate component prior to applying the component. Possible additives include, for example, catalysts, preferably ones that are not toxic, flow aids, surfactants, defoamers and other additives known to those skilled in the art. Any additive, which aids the formation of the polyurethane(urea) coating which encapsulates the fertilizer particles, may be included in one or both of these components.

Suitable fertilizer particles for the present encapsulation process include any chemical fertilizer. Some examples are ammonium sulfate, ammonium nitrate, urea, guanidine, melamine, sodium nitrate, ammonia phosphate, potassium phosphate, and combinations thereof. These fertilizer particles are obviously at least partially water soluble.

As used herein, the phrase “fertilizer particles” includes granular, pelletized, dusts, pilled and prilled fertilizers.

An attrition resistant, controlled release particulate fertilizer may be prepared by applying the components at ambient temperature, preferably, however, preheated to a temperature of between about 60 and 105° C. The fertilizer particles are kept in continuous low shear, low impact, motion relative to each other by a mixing apparatus. Examples of suitable mixing apparatus include fluid bed, rotating drum, pan pelletizer, and any others that can provide a continuous, low shear motion of the fertilizer particles.

More specifically, attrition resistant, controlled release fertilizers may be produced by (i) providing a quantity of fertilizer particles, (ii) agitating the fertilizer particles such that a gentle mixing thereof is maintained, (iii) adding to the agitated fertilizer particles either an isocyanate component or an isocyanate-reactive component, (iv) after the component has spread uniformly, adding to the agitated fertilizer particles an inert filler, (v) adding the other reactive component, in an amount such that the ratio of NCO groups to isocyanate-reactive groups is from about 2.0 to about 0.8, more preferably 1.2 to 0.9, and most preferably 1.1 to 0.93, (vi) allowing the polyisocyanate and the isocyanate-reactive materials to react, thus forming a solidified polyurethane(urea) coating on the fertilizer particles, and (vii) cooling the coated fertilizer particles to about or slightly above room temperature, with continuous agitation. As noted above, step (iii) can be conducted after the filler has been mixed with the fertilizer particles. In another embodimeent, step (iv) follwos the addition of the other reactive component. If multiple coatings are desired to achieve slower release of the fertilizer, steps (ii), (iii) and (v) can be repeated several times.

In accordance with the present invention, it is not necessary that the fertilizer particles contain reactive functional groups, and it is preferred that the fertilizer particles contain less than 10% by weight of reactive functional groups.

Metering of the streams of the polyisocyanate component and the isocyanate-reactive component onto the fertilizer particles can be continuous. It may be, however, advantageously discontinuous, when only a portion of the total amount of each of the two reactants is added and allowed to react prior to applying additional portions.

Successful application of the coatings of the present invention to particulate fertilizers depends on factors such as i) correct metering of the co-reactants, ii) fairly precise temperature control, iii) continuous movement of fertilizer particles during application of the optionally successive urethane coatings, and iv) followed by cooling to avoid agglomeration of the fertilizer particles.

The following examples further illustrate details for the process of the present invention, and the preparation the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

Urea Pellets: urea 98% pellets, commercially available from Acros Organies
TPG: tripropylene glycol
TPG-COM1: a 50/50 mixture of TPG and S60
TPG-COM2: a 60/40 mixture of TPG and S38
TPG-COM3: an 85/15 mixture of TPG and K1
POLYOL A: a sucrose/propylene glycol/water initiated propylene oxide polyether polyol having an hydroxy functionality of about 6.2, an OH number of 340 and an equivalent weight of about 165.
POLYOL A-COM1: a 65/35 mixture of POLYOL A and S38
POLYOL B: a trimethylolpropane initiated propylene oxide polyether triol having an hydroxy functionality of 3, an OH number of about 370 and an equivalent weight of about 152.
ISO: a polymethylene poly(phenylisocyanate) containing about 61% diphenylmethane diisocyanate monomers having a 2,4′-isomer content of about 18% by weight, a 2,2′-isomer content of about 2% based on the total weight of the polymethylene poly(phenylisocyanate), and 39% by weight of higher functionality homologs, and having an overall isocyanate group content of about 32.4% and a functionality of about 2.5.
ISO-COM1: a 50150 mixture of ISO and S60
ISO-COM2: a 65/35 mixture of ISO and S38
ISO-COM3: a 60/40 mixture of ISO and S38
ISO—COM4: a 85/15 mixture of ISO and K1
   Fillers:
K1 — a commercially available product sold as Scotchlite K-1 Glass Bubbles from 3M, having a mean particle size of 65 microns.
S38— a commercially available product sold as Scotchlite S-38 Glass Bubbles from 3M, having a mean particle size of 40 microns
S60— a commercially available product sold as Scotchlite S-60 Glass Bubbles from 3M, having a mean particle size of 30 microns
ATH—a commercially available aluminum oxide trihydrate sold as CG-60 from LaRoche Chemicals, having a mean particle size of about 20 microns.
CAC: a commercially available calcium carbonate sold as 200-W from Georgia Marble Company, having a mean partilce size of about 35 microns

In the examples, one of the following six procedures was used to prepare the encapsulated fertilizer particles:

Procedure 1: The isocyanate was added to the fertilizer pellets in an 8 ounce jar at room temperaure and mixed for about 2 minutes. The isocyanate reactive component was then added at room temperature and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate and adding the isocyanate reactive component were repeated 2 more times (in the same amounts), with the addition being to the hot pellets, directly out of oven. Following the last coating, the pellets were kept in the oven for 1 hour.

Procedure 2: The isocyanate was added to the fertilizer pellets in an 8 ounce jar at room temperaure and mixed for about 2 minutes. Filler was then added to the isocyanate coated pellets and mixed for about 2 minutes. The isocyanate reactive component was then added at room temperature and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate, the filler and the isocyanate reactive component were repeated 2 more times (in the same amounts), with the addition being to the hot pellets, directly out of oven. Following the last coating, the pellets were kept in the oven for 1 hour.

Procedure 3: Filler was added to the fertilizer pellets in an 8 ounce jar at room temerapture and mixed for about 2 minutes. The isocyanate was then added to the fertilizer pellets/filler mixture at room temperaure and mixed for about 2 minutes. The isocyanate reactive component was then added at room temperature and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate, the filler and the isocyanate reactive component were repeated 2 more times (in the same amounts), with the addition being to the hot pellets, directly out of oven. Following the last coating, the pellets were kept in the oven for 1 hour.

Procedure 4: The isocyanate was added to the fertilizer pellets in an 8 ounce jar at room temperaure and mixed for about 2 minutes. The isocyanate reactive component was then added at room temperature and mixed for about 2 minutes. Filler was then added to the coated pellets and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate, the filler and the isocyanate reactive component were repeated 2 more times (in the same amounts), with the addition being to the hot pellets, directly out of oven. Following the last coating, the pellets were kept in the oven for 1 hour.

Procedure 5: The isocyanate reactive component was added to the fertilizer pellets in an 8 ounce jar at room temperaure and mixed for about 2 minutes. Filler was then added to the coated pellets and mixed for about 2 minutes. The isocyanate component was then added at room temperature and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate reactive component, the filler and the isocyanate were repeated 2 more times (in the same amounts), with the addition being to the hot pellets, directly out of oven. Following the last coating, the pellets were kept in the oven for 1 hour.

Procedure 6: The isocyanate reactive component was added to the fertilizer pellets in an 8 ounce jar at room temperaure and mixed for about 2 minutes. The isocyanate was then added at room temperature and mixed for about 2 minutes. The pellets were poured onto an aluminum tray and placed in 110° C. oven for 10-15 minutes until the pellets were dry and were no longer tacky. The pellets were agitated 2 or 3 times while in the oven to prevent the pellets from sticking together. The steps of adding the isocyanate and adding the isocyanate reactive component were repeated 2 more times (in the same amounts), with the addition being to the hot pellets, directly out of oven. Following the last coating, the pellets were kept in the oven for 1 hour.

The % encapsulation was determined by subtracting the amount of encapsulation retained on the wall of the glass jar from the total amount of encapsulation material added to the pellets.

Test Procedure for Slow Release Properties:

After one week, the encapsulated fertilizer granules from each the examples were compared to unmodified fertilizer pellets using the following test procedure: 20 g of the fertilizer pellets were combined with 80 g of water, and stored at room temperature in a closed glass jar for 8 hrs. After this time, the solids were filtered off and the amount of solids dissolved in the aqueous phase was determined after evaporation of the water for 4 hours in a 100° C. oven. The lower the % fertizer dissolved, the slower the release rate.

The formuations and procedures used and the results obtained were set forth in Table 1 below. Examples 1, 2, 7, 11, 13 and 15 were comparative examples.

| | Example | | | | | | | | |
|---|---|---|---|---|---|---|---|---|---|
| | 1 | 2 | 3 | 4 | 5 | 6 | 7 | 8 | 9 |
| Urea pellets | 100 | 100 | 100 | 100 | 100 | 100 | 100 | 100 | 100 |
| ISO | — | 1.285 | 0.90 | 0.90 | 0.90 | 0.643 | — | 0.70 | 0.73 |
| ISO-COM1 | — | — | — | — | — | — | 1.286 | — | — |
| ISO-COM2 | — | — | — | — | — | — | — | — | — |
| ISO-COM3 | — | — | — | — | — | — | — | — | — |
| ISO-COM4 | — | — | — | — | — | — | — | — | — |
| TPG | — | 0.845 | 0.592 | 0.592 | 0.592 | 0.423 | — | — | — |
| TPG-COM1 | — | — | — | — | — | — | 0.846 | — | — |
| TPG-COM2 | — | — | — | — | — | — | — | — | — |
| TPG-COM3 | — | — | — | — | — | — | — | — | — |
| POLYOL A | — | — | — | — | — | — | — | 0.791 | — |
| POLYOL A-COM1 | — | — | — | — | — | — | — | — | — |
| POLYOL B | — | — | — | — | — | — | — | — | 0.76 |
| S60 | — | — | 0.639 | 0.639 | 0.639 | 1.066 | — | 0.639 | 0.64 |
| S38 | — | — | — | — | — | — | — | — | — |
| K1 | — | — | — | — | — | — | — | — | — |
| CAC | — | — | — | — | — | — | — | — | — |
| ATH | — | — | — | — | — | — | — | — | — |
| % Filler in encapsulent | 0 | 0 | 30 | 30 | 30 | 50 | 50 | 30 | 30 |
| Procedure | — | 1 | 4 | 3 | 2 | 2 | 1 | 5 | 5 |
| % Encapsulation | 0 | 5.29 | 5.29 | 5.29 | 5.29 | 5.29 | 5.29 | 5.29 | 5.29 |
| % Fertilizer dissolved | 90.1 | 83.5 | 33.1 | 50.1 | 34.6 | 48.2 | *a | 6.5 | 28.7 |
| | Example | | | | | | | | |
| | 10 | 11 | 12 | 13 | 14 | 15 | 16 | 17 | 18 |
| Urea pellets | 100 | 100 | 100 | 100 | 100 | 100 | 100 | 100 | 100 |
| ISO | 0.65 | — | 0.771 | — | 1.092 | — | 0.90 | 0.90 | 0.6425 |
| ISO-COM1 | — | — | — | — | — | — | — | — | — |
| ISO-COM2 | — | 1.00 | — | — | — | — | — | — | — |
| ISO-COM3 | — | — | — | 1.00 | — | — | — | — | — |
| ISO-COM4 | — | — | — | — | — | 1.285 | — | — | — |
| TPG | — | — | 0.507 | — | 0.718 | — | 0.592 | 0.592 | 0.4225 |
| TPG-COM1 | — | — | — | — | — | — | — | — | — |
| TPG-COM2 | — | — | — | 1.13 | — | — | — | — | — |
| TPG-COM3 | — | — | — | — | — | 0.845 | — | — | — |
| POLYOL A | 0.735 | — | — | — | — | — | — | — | — |
| POLYOL A-COM1 | — | 1.13 | — | — | — | — | — | — | — |
| POLYOL B | — | — | — | — | — | — | — | — | — |
| S60 | — | — | — | — | — | — | — | — | — |
| S38 | 0.746 | — | 0.852 | — | — | — | — | — | — |
| K1 | — | — | — | — | 0.32 | — | — | — | — |
| CAC | — | — | — | — | — | — | 0.639 | — | 1.065 |
| ATH | — | — | — | — | — | — | — | 0.639 | — |
| % Filler in encapsulent | 35 | 35 | 40 | 40 | 15 | 15 | 30 | 30 | 50 |
| Procedure | 5 | 6 | 2 | 1 | 2 | 1 | 2 | 2 | 2 |
| % Encapsulation | 5.29 | 5.29 | 5.29 | 5.29 | 5.29 | 5.29 | 5.29 | 5.29 | 5.29 |
| % Fertilizer dissolved | 12 | *b | 16.3 | *c | 53.6 | *d | 40.9 | 36.2 | 30.2 |

*a through *d - the ISO-COM1, ISO-COM2, ISO-COM3 AND ISO-COM4 and the TPG-COM1, TPG-COM2, TPG-COM3 and POLYOL A-COM1 blends were each thick pastes and not usable.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for producing polyurethane(urea) encapsulated, slow release fertilizer particles comprising:
a) applying a polyisocyanate component to fertilizer particles to form isocyanate coated fertilizer particles,
b) mixing an inert filler with said isocyanate coated fertilizer,
c) adding an isocyanate-reactive component to the mixture of step b) and
d) allowing the reactive components to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

2. The process of claim 1 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

3. The process of claim 1, wherein said filler containing polyurethane(urea) encapsulated fertilizer partilces contain from about 4 to about 12% by weight of filled polyurethane(urea).

4. The process of claim 1, wherein said ratio is from about 80:30 to about 30:70.

5. The process of claim 4, wherein said ratio is from about 60:40 to about 40:60.

6. The process of claim 1, wherein said filler is an inert, inorganic material which is insoluble or substantially insoluble in water and which contains at least 50% by weight of particles having a particle size of less than 100 microns.

7. A process for producing polyurethane(urea) encapsulated, slow release fertilizer particles comprising:
a) applying a polyisocyanate component to fertilizer particles to form coated fertilizer particles,
b) adding an isocyanate-reactive component to said coated fertilizer particles,
c) mixing an inert inorganic filler with the mixture of step b) before the isocyanate and isocyanate-reactive component react and
d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

8. The process of claim 7 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

9. The process of claim 7, wherein said filler containing polyurethane(urea) encapsulated fertilizer partilces contain from about 4 to about 12% by weight of filled polyurethane(urea).

10. The process of claim 7, wherein said ratio is from about 80:30 to about 30:70.

11. The process of claim 10, wherein said ratio is from about 60:40 to about 40:60.

12. The process of claim 7, wherein said filler is an inert, inorganic material which is insoluble or substantially insoluble in water and which contains at least 50% by weight of particles having a particle size of less than 100 microns.

13. A process for producing polyurethane(urea) encapsulated, slow release fertilizer particles comprising:
a) mixing fertilizer particles with an inert inorganic filler,
b) applying a polyisocyanate component to the mixture to form a mixture of coated fertilizer particles and coated inert filler,
c) adding an isocyanate-reactive component to the resultant mixture and
d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

14. The process of claim 13 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

15. The process of claim 13, wherein said filler containing polyurethane(urea) encapsulated fertilizer partilces contain from about 4 to about 12% by weight of filled polyurethane(urea).

16. The process of claim 13, wherein said ratio is from about 80:30 to about 30:70.

17. The process of claim 16, wherein said ratio is from about 60:40 to about 40:60.

18. The process of claim 13, wherein said filler is an inert, inorganic material which is insoluble or substantially insoluble in water and which contains at least 50% by weight of particles having a particle size of less than 100 microns.

19. A process for producing polyurethane(urea) encapsulated, slow release fertilizer particles comprising:
a) applying an isocyanate reactive component to fertilizer particles to form coated fertilizer particles,
b) mixing an inert inorganic filler with said coated fertilizer particles,
c) adding a polyisocyanate component to the mixture of step b) and
d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

20. The process of claim 19 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

21. The process of claim 19, wherein said filler containing polyurethane(urea) encapsulated fertilizer partilces contain from about 4 to about 12% by weight of filled polyurethane(urea).

22. The process of claim 19, wherein said ratio is from about 80:30 to about 30:70.

23. The process of claim 22, wherein said ratio is from about 60:40 to about 40:60.

24. The process of claim 19, wherein said filler is an inert, inorganic material which is insoluble or substantially insoluble in water and which contains at least 50% by weight of particles having a particle size of less than 100 microns.

25. A process for producing polyurethane(urea) encapsulated, slow release fertilizer particles comprising:
a) applying an isocyanate reactive component to fertilizer particles to form coated fertilizer particles,
b) adding a polyisocyanate to said coated fertilizer,
c) mixing an inert inorganic filler with the mixture of step b) before the isocyanate and isocyanate-reactive component react and
d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

26. The process of claim 25 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

27. The process of claim 25, wherein said filler containing polyurethane(urea) encapsulated fertilizer partilces contain from about 4 to about 12% by weight of filled polyurethane(urea).

28. The process of claim 25, wherein said ratio is from about 80:30 to about 30:70.

29. The process of claim 28, wherein said ratio is from about 60:40 to about 40:60.

30. The process of claim 25, wherein said filler is an inert, inorganic material which is insoluble or substantially insoluble in water and which contains at least 50% by weight of particles having a particle size of less than 100 microns.

31. A process for producing polyurethane(urea) encapsulated, slow release fertilizer particles comprising:
a) mixing fertilizer particles with an inert inorganic filler,
b) applying an isocyanate reactive component to the mixture to form a mixture of coated fertilizer particles and coated inert filler,
c) adding a polyisocyanate component to the resultant mixture and
d) allowing the reactive components to react to form filler containing polyurethane(urea) encapsulated fertilizer particles containing from about 1 to about 15 percent by weight of filled polyurethane(urea), said percent by weight based on the total weight of the encapsulated fertilizer, with the proviso that the weight ratio of polyurethane(urea) to filler is from about 80:20 to about 30:70.

32. The process of claim 31 wherein steps a), b), c) and d) are repeated (successively) as many times as necessary, with the polyurethane(urea) encapsulated fertilizer particles from the previous step d) being substituted for the fertilizer particles in step a), so as to form polyurethane(urea) encapsulated fertilizer particles containing from about 1 to about 15% by weight of filled polyurethane(urea) based on the total weight of the encapsulated fertilizer.

33. The process of claim 31, wherein said filler containing polyurethane(urea) encapsulated fertilizer partilces contain from about 4 to about 12% by weight of filled polyurethane(urea).

34. The process of claim 31, wherein said ratio is from about 80:30 to about 30:70.

35. The process of claim 34, wherein said ratio is from about 60:40 to about 40:60.

36. The process of claim 31, wherein said filler is an inert, inorganic material which is insoluble or substantially insoluble in water and which contains at least 50% by weight of particles having a particle size of less than 100 microns.
